(19) United States
(12) Patent Application Publication
(10) Pub. No.: US 2015/0113452 A1
(43) Pub. Date: Apr. 23, 2015

(54) GRAPHICAL USER INTERFACE

(71) Applicant: Cyan Inc., Petaluma, CA (US)

(72) Inventors: Blake Dana Tullysmith, Santa Rosa, CA (US); Zsolt Haraszti, Santa Rosa, CA (US)

(73) Assignee: Cyan Inc., Petaluma, CA (US)

(21) Appl. No.: 14/056,483

(22) Filed: Oct. 17, 2013

(51) Int. Cl. G06F 3/0481

(52) U.S. Cl. CPC G06F 3/04817
USPC 715/765

(57) ABSTRACT

A graphical user interface system for a computer system is disclosed. Regions of interest and locations thereof are defined. Icons are associated with the regions and the sizing and arrangement thereof is determined according to rules, such as user-specified rules. A representation of the icons of a region may be enhanced or altered in response to user interaction. An altered representation may animate icons of a region, enlarge an icon, augment information displayed on an icon, or perform other functions.

### BACKGROUND

1. Field of the Invention

This invention relates to systems and methods for providing a graphical user interface to a computer system, and, in particular, resources accessible on a computer system.

2. Background of the Invention

A computer file system is typically a hierarchical structure in which a root directory has directories associated therewith, which may also have sub-directories, and so on. Any directory may also contain any number of data files. The file system is viewable and represented in a hierarchical fashion. Typically a user must traverse the hierarchy in order to access a file or directory at a depth within the hierarchy, i.e. successively open directories at each level up to that depth. This is a tedious and time-consuming process and does not necessarily reflect how a user actually perceives the file system or uses the files.

The systems and methods described herein provide an improved approach for representing a file system and other assets in a graphical user interface.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a computer system suitable for implementing methods in accordance with embodiments of the invention;

FIG. 2 is a process flow diagram of a method for providing a graphical user interface in accordance with an embodiment of the present invention;

FIG. 3 is a schematic diagram of a user interface in accordance with an embodiment of the present invention;

FIG. 4 is a schematic diagram of a user interface reconfigured in accordance with an embodiment of the present invention;

FIGS. 5A through 5D are schematic diagrams of animation schemes for a graphical user interface in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for providing access to the file system of a computer system, applications, or other assets of a computer system accessible by means of a graphical user interface.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

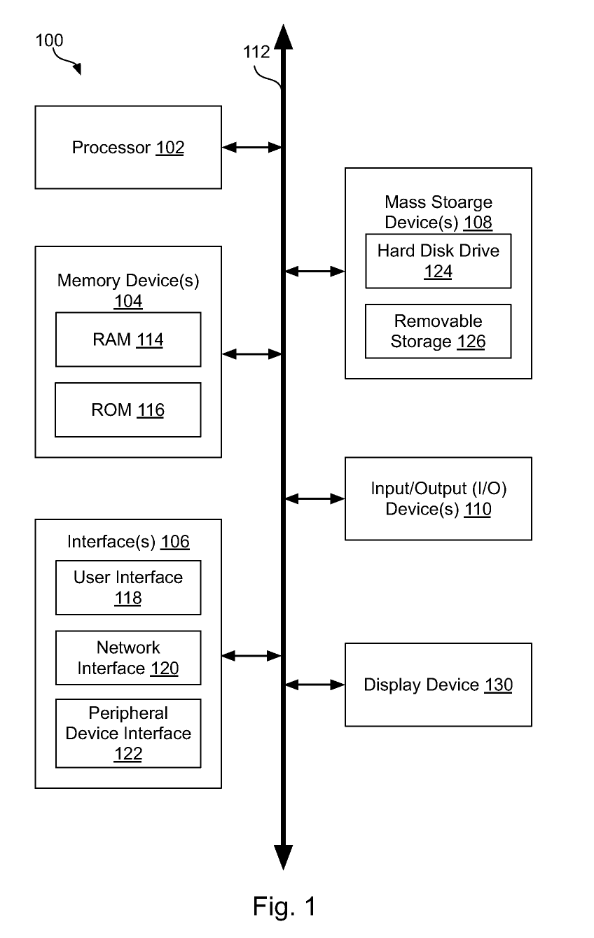

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

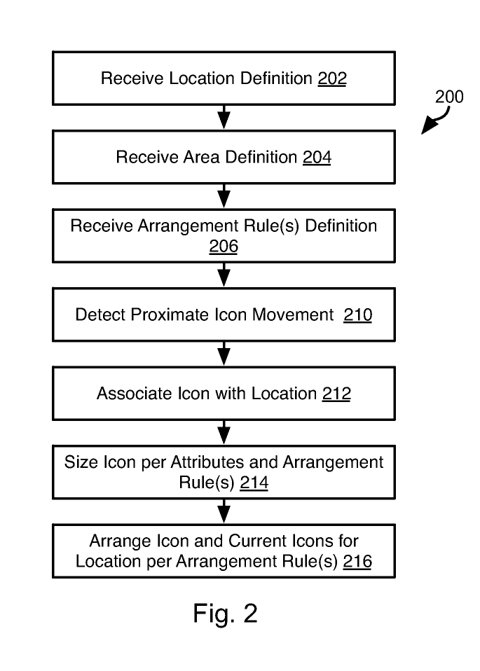

FIG. 2 illustrates a method 200 for providing a graphical user interface. The method 200 may be executed by a windowing system of an operating system or some other software module. The method 200 may be executed with respect to files and folders of a file system accessible by a computer system, such as a computer system 100 of FIG. 1. In addition to files and folders, icons representing applications, storage devices, peripheral devices, websites, or any other computing resource accessible by a computer system 100 may be represented and manipulated by a user according to the methods disclosed herein.

The method 200 may include receiving 202 a location definition. The location definition may be received by receiving a user selection of a point on a desktop by means of a pointing device (e.g. a mouse clock), detecting touching a location on a touch screen or some other specification of two-dimensional coordinates within a desktop environment.

The method 200 may further include receiving 204 an area definition about the point. The area may be received 204 by receiving a user selection of corners of a rectangle, e.g. dragging a corner of a rectangle to a location of the desktop offset from the point. In some embodiments, receiving 204 the area definition may include receiving a definition of an area of influence about the point. The area of influence may be defined as a field centered on the point and may have a field strength varying according to a radius R from the point, such as A/R, A/R̂2, or some other function of the form A(R̂(−N)), or a power series of such terms, where A is a scaling value and N is an arbitrary positive integer. In some embodiments, the field may have a strength corresponding to a natural occurring field such as a gravity field, electromagnetic field, or some other field. In some embodiments, the area of influence about the point may be specified by default such that no receiving step 204 is required, but may be performed if an instruction to do so is provided by the user. For example, a user may be prompted to either accept a default area of influence or specify the area of influence, e.g. values of A or N or other parameters.

The method 200 may further include receiving 206 from a user one or more arrangement rules. The arrangement rules may specify rules for determining one or both of the size and arrangement of icons. For example, a rule may specify that a size of an icon associated with a file shall be a function of its size, how recently it was opened, how recently it was modified, how recently it was created, or some other attribute. A size of an icon may also be specified to be related to its type. For example, applications may be ranked such that files associated with a given application will be represented by icons of a given size corresponding to the given application's rank. In a like manner a tag or file extension (.doc, .txt, etc.) may be ranked and the size of the icon for a given file may be determined according to the rank associated with one or both of a tag or file extension of the file, e.g. the higher the rank the larger the icon. Receiving 206 the one or more arrangement rules may include receiving a rule specifying some or all of the above sizing criteria. Where multiple sizing rules are specified, the size assigned to an icon may be based on a combination of these rules. For example, a size according to each rule of multiple rules may be combined, e.g. summed, weighted and summed, averaged, or otherwise combined, to determine a final size for the icon.

The received 206 rules may further specify rules for arranging icons within a defined area. For example, where “field” type area of influence is defined about a location, the arrangement rule may specify that larger icons be placed closer to a perimeter of the area of influence and smaller icons be placed closer to the center of the area of influence, or vice versa. An arrangement rule may specify a top to bottom and/or left to right ordering of icons based on size or any of the attributes noted above that may be used to determine the size of an icon.

An icon may be associated with a location as received 202 by means of detecting a conventional drag-and-drop of an icon by a user using a pointing device or touch screen as known in the art. In some embodiments, the boundary of an area of influence may not be visible, e.g. represented by a line or other visible indicator. Accordingly, a “snap” operation may be used to associate an icon with an area of influence. For example, movement of an icon, e.g. dragging of the icon, may be detected 210 to within a given proximity to the received 202 location. In response to this detection, the icon may be associated 212 with the received 202 location and sized 214 and arranged 216 about the received 202 location according to the received 206 rules.

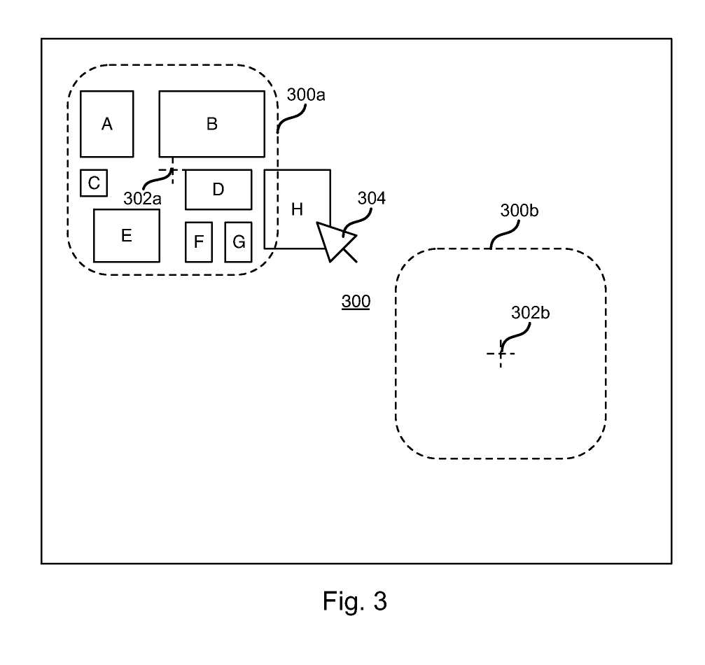

Referring to FIG. 3, a desktop 300, such as displayed on a screen of a display device, may include one or more regions 300a, 300b or areas of influence 300a, 300b centered or otherwise associated with locations 302a, 302b of the desktop. The regions 300a, 300b and locations 302a, 302b may be defined as described above with respect the method 200.

As shown, icons A-G are positioned within the region 300a and have variable sizes, such as sizes determined according to the method 200. A user may select an icon H, such as using a cursor 304, and drag the icon H into proximity to the region 300a or location 302a. As noted above, the region 300a may not be marked by a visible boundary, accordingly dragging the icon H to within some threshold distance of the location 302a may be interpreted as an indicator of user intention to add the icon H to the icons associated with the location 302a. The threshold distance may be defined as some fixed distance, a threshold “field strength” as defined by a field function about the location 302a. The distance may be measured with respect to the location 302a or with respect to a boundary within which other icons (A-G) lie that are associated with the location 302a.

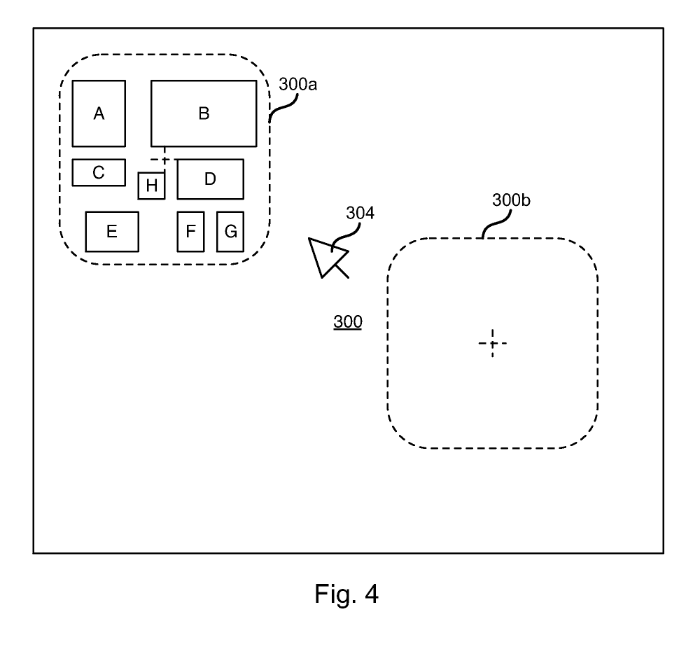

As shown in FIG. 4, in response to detecting the user's intention to associate the icon H with the region 300a and location 302a, the icons may be resized and rearranged to include the icon H. In some embodiments, the size of icons is determined with respect to other icons associated with respect to the same region. For example, the icon sizing rules may be relative sizing rules, such that as more icons are added, the sizes of icons may be diminish to make room for other icons. For example, as shown in FIG. 4, a number of the icons are resized in response to the adding of icon H.

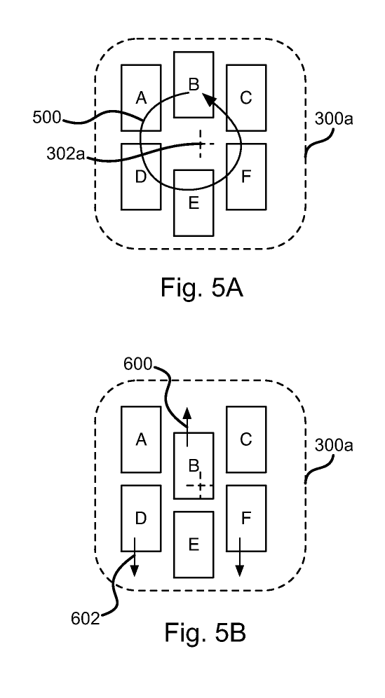

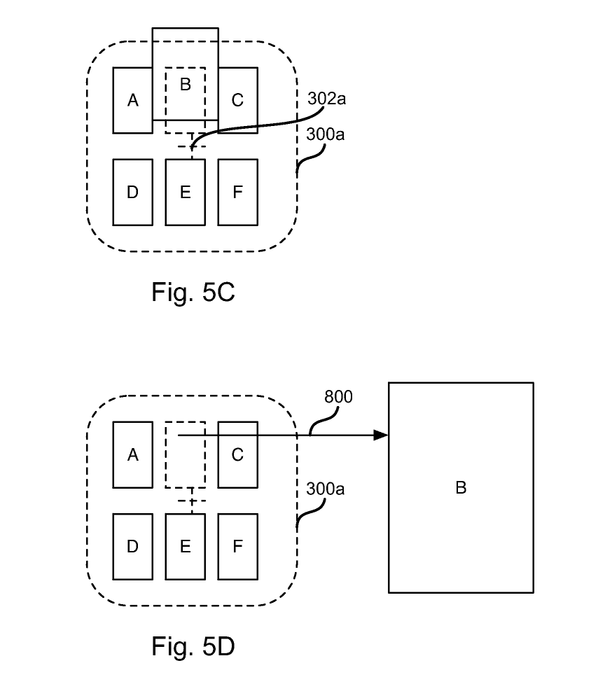

Referring to FIGS. 5A-5D in order to view, or enhance the view, of icons associated with a region 300a, the representation of icons associated with a region 300a may be altered or enhanced in response to a user interaction. For example, a user may click, tap, or otherwise interact, within the region 300a or a center or central portion, of the region 300a. In some embodiments, simply hovering with a cursor or single tapping in any of these regions may invoke an altered or enhanced display of the icons associated with a region 300a.

Referring to FIG. 5A, in some embodiments orbiting of the icons A-F about a point, such as the location 302a may be performed in response to such an interaction. The rotation may be within a plane of the screen, e.g. a vertical and horizontal plane. In other embodiments, the plane of rotation may be at an angle relative to the plane of a screen, e.g. an angle of between 30 and 90 degrees. Where orbiting is in a plane other than the plane of the screen the size of icons may increase as they orbit closer to the user in accordance with a simulated three-dimensional effect.

Referring to FIG. 5B, in another implementation, in response to any of the interactions listed above, the icons A-F may be animated such that they bounce, such as in a vertical direction. As shown in FIG. 5B, icons may bounce in one direction, whereas adjacent icons bounce in an opposite direction.

Referring to FIG. 5C, in some embodiments, in response to a user clicking on, hovering over, or otherwise interacting with an icon within a region 300a, the icon may be made to appear to bounce toward the viewer, e.g. be enlarged to show the icon more clearly. For example, icon B is shown larger than a prior representation of the icon shown in a dotted line.

Referring to FIG. 5D, in an alternative embodiment, an icon may be both enlarged and translated to adjacent the region 300a in response to any of the interactions noted above with respect to FIG. 5C. For example, as shown the icon B is enlarged and translated with respect to its original size and location shown in dotted lines. As for the embodiment of FIG. 5C, the amount of information displayed on an icon may be enhanced.

For any of the embodiments disclosed herein, the amount of information displayed on an icon may be determined based on its size. Information associated with a file, folder, application, or other resource associated with an icon may be ranked. As the size increases, information may be added to the icon based in accordance with the rankings For example, for a smaller size, only the name may be shown. For a larger size the name and date modified may be shown. For a still larger size, a first line, summary, or other sampling of data of the resource associated with the icon may be shown. In addition to this information, other information that may optionally be displayed on an icon may include a date created, date opened, size, or other information.

In addition to displaying icons, a title or other information may be associated with a region 300a. For example, a title may be automatically generated or input by a user upon creation of a region 300a or at some other point in response to a user instruction and input to specify a title. Other information may also be displayed with a region 300a, such as its size, the number of icons associated therewith, or the like.

In addition to the methods disclosed herein, the sizes and/or arrangement of icons may also be manually or specified by a user. For example, a user may specify a size of an icon by specifying a numeric size or dragging a corner or side of an icon in order to resize the icon and this new size may be associated with that icon by the executing computer system. In response to such an explicit resizing, the other icons of a region 300a may be rearranged and/or resized according to one or more arrangement and resizing rules to accommodate the resized icon as described above.

Icons arranged and displayed according to the methods disclosed herein may function as icons according to methods known in the art. In particular, upon detecting selection of an icon (by clicking, tapping, hovering, or the like) in a manner indicating a user intent to use a resource associated with the icon, the computer system associated with the display on which the icons are presented may then invoke a display of interface for interacting with the resource associated with the icon, e.g. a representation of a folder containing files, invoke opening of an application represented by the icon, invoke opening of an application associated with a file represented by the icon, or other interface for any computing resource represented by an icon.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for providing an interface, the method comprising, by a computer system:
providing a graphical desktop representative of the computer system, the computer system having a plurality of computing resources;
receiving a user specification of icon sizes for a plurality of icons, each icon of the plurality of icons representing a resource of the plurality of computing resources;
generating in the graphical desktop a representation of the plurality of icons, wherein the icons have non-identical sizes in accordance with the user specification; and
transmitting the graphical desktop for display on a display device coupled to the computer system.

2. The method of claim 1, wherein receiving the user specification of icon sizes comprises receiving user adjustments to a size of at least one icon of the plurality of icons.

3. The method of claim 2, wherein receiving user adjustments to the size of the at least one icon comprises receiving users interactions with a representation of the at least one icon in the graphical desktop from a pointing device.

4. The method of claim 1, further comprising receiving a user specification of a region of the graphical desktop;
wherein receiving the user specification of icon sizes for the plurality of icons comprises receiving an icon sizing rule for the region; and
wherein generating in the graphical desktop the representation of the plurality of icons comprises—
determining that a portion of the plurality of icons are located within the region; and
associating sizes with the portion of the plurality of icons according to the icon sizing rule.

5. The method of claim 4, wherein the sizing rule specifies a relationship between size of an icon and an attribute of a computing resource of the plurality of the plurality of computing resources associated therewith.

6. The method of claim 5, wherein the attribute includes at least one of a size, type, last modification date, and date created.

7. The method of claim 4, wherein receiving a user specification of a region of the screen comprises receiving a user specification of a point in the graphical desktop, the point having an influence zone expanding outwardly therefrom.

8. The method of claim 7, further comprising, detecting movement of one of a cursor interacting with an icon of the plurality of icons and the icon into the influence zone;
in response to the detecting, associating the icon of the plurality of icons with the region.

9. The method of claim 8, wherein the influence zone simulates a field about the point.

10. The method of claim 4, further comprising generating an animated representation of the portion of the plurality of icons in response to user interaction with the region.

11. A computer system comprising one or more processors and one or more memory devices operably coupled to the one or more processors, the one or more memory devices storing executable and operational data effective to cause the one or more processors to:
provide a graphical desktop representative of a computer system, the computer system storing a plurality of folders and a plurality of files distributed among the plurality of folders;
receive a user specification of icon sizes for a plurality of icons, each icon of the plurality of icons representing one of a folder of the plurality of folders and a file of the plurality of files;
generate in the graphical desktop a representation of the plurality of icons, wherein the icons have non-identical sizes in accordance with the user specification; and
transmit the graphical desktop for display on a display device coupled to the computer system.

12. The computer system of claim 11, wherein the executable and operational data are further effective to cause the one or more processors to receive the user specification of icon sizes by receiving user adjustments to a size of at least one icon of the plurality of icons.

13. The computer system of claim 12, the executable and operational data are further effective to cause the one or more processors to receive user adjustments to the size of the at least one icon by receiving users interactions with a representation of the at least one icon in the graphical desktop from a pointing device.

14. The computer system of claim 11, the executable and operational data are further effective to cause the one or more processors to:
receive a user specification of a region of the graphical desktop;
receive the user specification of icon sizes for the plurality of icons by receiving an icon sizing rule for the region; and
generate in the graphical desktop the representation of the plurality of icons by—
determining that a portion of the plurality of icons are located within the region; and
associating sizes with the portion of the plurality of icons according to the icon sizing rule.

15. The computer system of claim 14, wherein the sizing rule specifies a relationship between size of an icon and an attribute of one of a file of the plurality of files and a folder of the plurality of folder's represented by the icon.

16. The computer system of claim 15, wherein the attribute includes at least one of a size, type, last modification date, and date created.

17. The computer system of claim 14, the executable and operational data are further effective to cause the one or more processors to receive a user specification of a region of the screen by receiving a user specification of a point in the graphical desktop, the point having an influence zone expanding outwardly therefrom.

18. The computer system of claim 17, the executable and operational data are further effective to cause the one or more processors to:
detect movement of one of a cursor interacting with an icon of the plurality of icons and the icon into the influence zone;
in response to the detecting movement, associate the icon of the plurality of icons with the region.

19. The computer system of claim 18, wherein the influence zone simulates a gravity field about the point.

20. The computer system of claim 14, the executable and operational data are further effective to cause the one or more processors to generate an animated representation of the portion of the plurality of icons in response to user interaction with the region.
